(19) United States
(12) Patent Application Publication
(10) Pub. No.: US 2023/0324248 A1
(43) Pub. Date: Oct. 12, 2023

(54) WIRELESS MOISTURE DETECTION SYSTEM

(71) Applicant: X Development LLC, Mountain View, CA (US)

(72) Inventors: Thomas Robert Swanson, Sunnyvale, CA (US); Harrison Pham, Sunnyvale, CA (US)

(21) Appl. No.: 17/715,576

(22) Filed: Apr. 7, 2022

(51) Int. Cl. G01M 3/18; G01N 27/12; H04Q 9/00; H04N 5/225

(52) U.S. Cl. CPC G01M 3/186; G01N 27/121; H04Q 9/00; H04N 5/2251; H04Q 2209/47; H04N 2005/2255

(57) ABSTRACT

In one aspect, there is provided a moisture detection system that includes: a moisture detection unit including: a moisture sensor configured to obtain a measurement that indicates an amount of moisture, and a Radio Frequency Identification (RFID) module coupled to the moisture sensor through multiple wires, where the RFID module includes an antenna and is configured to wirelessly transmit a telemetry message based on the measurement from the moisture sensor through the antenna and is further configured to wirelessly receive energy for powering the moisture detection unit through the antenna; and a control unit communicatively coupled to the moisture detection unit, where the control unit is configured to wirelessly receive the telemetry message from the RFID module and process the telemetry message to determine the amount of moisture measured by the moisture sensor.

### TECHNICAL FIELD

This specification relates to sensor systems for moisture detection, and more specifically, to a moisture detection system that can be used to detect moisture wirelessly.

### BACKGROUND

Taking measurements underwater in an accurate and cost-effective manner can be a challenging task. Such measurements may generally be required in different settings, one example of which is aquaculture, e.g., breeding, rearing, and harvesting of aquatic livestock under controlled conditions. Monitoring the feeding behavior of aquatic livestock by using a camera can be important for, e.g., determining the amount of feed that is being consumed by the livestock and modifying the feeding regiment accordingly.

However, leaks and seawater ingress remain one of the leading causes of failure of underwater camera systems. The leaks are typically too small to be detected by onboard pressure and humidity sensors, but the seawater can nevertheless cause corrosion and component failures. In some cases, the leaks can start within components of the camera that are difficult to access or otherwise inaccessible from the main body of the camera. Furthermore, frequently replacing such systems can be expensive and time-consuming.

### SUMMARY

Implementations of the present disclosure include moisture detection systems. More particularly, implementations of the present disclosure include a moisture detection system that can be used to monitor for leaks in different objects and devices, e.g., in an underwater camera, particularly in locations where it may be otherwise difficult, or impossible, to obtain moisture measurements.

The moisture detection system can include a moisture detection unit and a control unit. The moisture detection unit can obtain a measurement indicating an amount of moisture and wirelessly transmit, e.g., using Radio Frequency Identification (RFID) technology, the measurement to the control unit. The control unit can wirelessly receive the measurement and process it to determine the amount of moisture measured by the moisture detection unit.

According to a first aspect, there is provided a moisture detection system that includes: a moisture detection unit including: a moisture sensor configured to obtain a measurement that indicates an amount of moisture, and a Radio Frequency Identification (RFID) module coupled to the moisture sensor through multiple wires, where the RFID module includes an antenna and is configured to wirelessly transmit a telemetry message based on the measurement from the moisture sensor through the antenna and is further configured to wirelessly receive energy for powering the moisture detection unit through the antenna; and a control unit communicatively coupled to the moisture detection unit, where the control unit is configured to wirelessly receive the telemetry message from the RFID module and process the telemetry message to determine the amount of moisture measured by the moisture sensor.

In some implementations, the moisture detection unit is disposed within an enclosed cavity of a device, and where the antenna is configured to wirelessly transmit the telemetry message from within the enclosed cavity and to the control unit.

In some implementations, the moisture detection unit is coupled to an object, and where the control unit is remote from the object.

In some implementations, the moisture sensor includes an absorbent pad configured to absorb the moisture, and where the measurement that indicates the amount of moisture is based on a resistance of the absorbent pad as measured by the wires.

In some implementations, the absorbent pad includes cotton, salt, and water.

In some implementations, the RFID module and the moisture sensor are coupled to each other through an adhesive.

In some implementations, the RFID module includes: an analog front-end device coupled to the moisture sensor through the wires and configured to both receive the measurement from the moisture sensor and generate a corresponding voltage signal, and an RFID transponder configured to receive the voltage signal from the front-end device and generate the telemetry message based on the voltage signal.

In some implementations, the RFID transponder includes: an analog-to-digital converter configured to receive the voltage signal from the analog front-end device and convert it to a digital signal, a microcontroller configured to receive the digital signal from the analog-to-digital converter and generate the telemetry message, and where the antenna is configured to receive the telemetry message and wirelessly transmit the telemetry message to the control unit.

In some implementations, the RFID transponder is configured to have a wireless transmission range of up to 1.5 meters.

In some implementations, the moisture detection unit is coupled with an adhesive to an enclosure of a device, and where the measurement that indicates the amount of moisture indicates the amount of moisture inside the enclosure.

In some implementations, the moisture detection unit is coupled with an adhesive to an enclosed cavity of an underwater camera, and where the measurement that indicates the amount of moisture indicates the amount of moisture inside the enclosed cavity.

In some implementations, the moisture sensor is configured to automatically and periodically obtain the measurement that indicates the amount of moisture.

In some implementations, the control unit is configured to generate a time series of moisture measurements indicating the amount of moisture measured by the moisture sensor at different time points.

In some implementations, the system further includes a power source that is configured to power the moisture detection unit and the control unit.

In some implementations, the system further includes an alert unit configured to automatically generate an alert in response to the control unit determining that the amount of moisture measured by the moisture sensor satisfies an alert criteria.

In some implementations, the moisture detection unit includes multiple moisture sensors at different locations, each moisture sensor being coupled to the RFID module, and each moisture sensor configured to obtain a respective measurement that indicates a respective amount of moisture at a respective location of the different locations.

According to a second aspect, there is provided a method that includes: obtaining, by a moisture sensor of a moisture detection system that includes: (i) a moisture detection unit including the moisture sensor and a Radio Frequency Identification (RFID) module coupled to the moisture sensor and configured to wirelessly receive energy for powering the moisture detection unit through an antenna, and (ii) a control unit communicatively coupled to the moisture detection unit, a measurement that indicates an amount of moisture, wirelessly transmitting, by the RFID module and through the antenna, a telemetry message based on the measurement from the moisture sensor, wirelessly receiving, by the control unit, the telemetry message from the RFID unit, and processing, by the control unit, the telemetry message to determine the amount of moisture measured by the moisture sensor.

According to a third aspect, there are provided one or more non-transitory computer storage media storing instructions that, when executed by one or more computers, cause the one or more computers to perform operations of the method of any preceding aspect.

Implementations of the present disclosure provide one or more of the following technical advantages and improvements over previously available solutions.

The moisture detection system described in this specification is wireless, relatively small, and passively-powered. Accordingly, it can be easily installed and effectively used in locations where detecting leaks may otherwise be a challenge. For example, in the case of underwater cameras, the moisture detection system can be placed at locations within the camera that are difficult to access, or otherwise inaccessible, from the main body of the camera.

Wireless communication enables the moisture detection system to effectively transmit moisture measurements for further analysis to other components, e.g., a central controller located remotely from the moisture measurement system, which can automatically generate corresponding alerts and action requests. Accordingly, the moisture detection system can enable an automated field-failure detection and mitigation network. For example, the moisture detection system can allow underwater cameras to automatically self-diagnose and mark themselves for replacement, which can significantly reduce the costs of their operation and repair.

The moisture sensor, included in the moisture detection system, can be configured to detect relatively small amounts of moisture. For example, the moisture sensor can include a cotton pad that can be sensitive and highly absorbent. Accordingly, because leaks tend to be slow and gradual, the moisture detection system can indicate that a leak is present early on, such that an appropriate action could be taken to mitigate any damage to the camera, thereby extending overall lifetime of the camera and minimizing downtime.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example application of a moisture detection system.

FIG. 2 is a block diagram of an example moisture detection unit included in a moisture detection system.

FIG. 3 is a block diagram of an example moisture detection network.

FIG. 4 is a flow diagram of an example process determining an amount of moisture using a moisture detection system.

FIG. 5A illustrates an example placement of a moisture detection unit included in a moisture detection system.

FIG. 5B illustrates another example placement of a moisture detection unit included in a moisture detection system.

FIG. 5C illustrates another example placement of a moisture detection unit included in a moisture detection system.

Like reference symbols in the various drawings indicate like elements.

### DETAILED DESCRIPTION

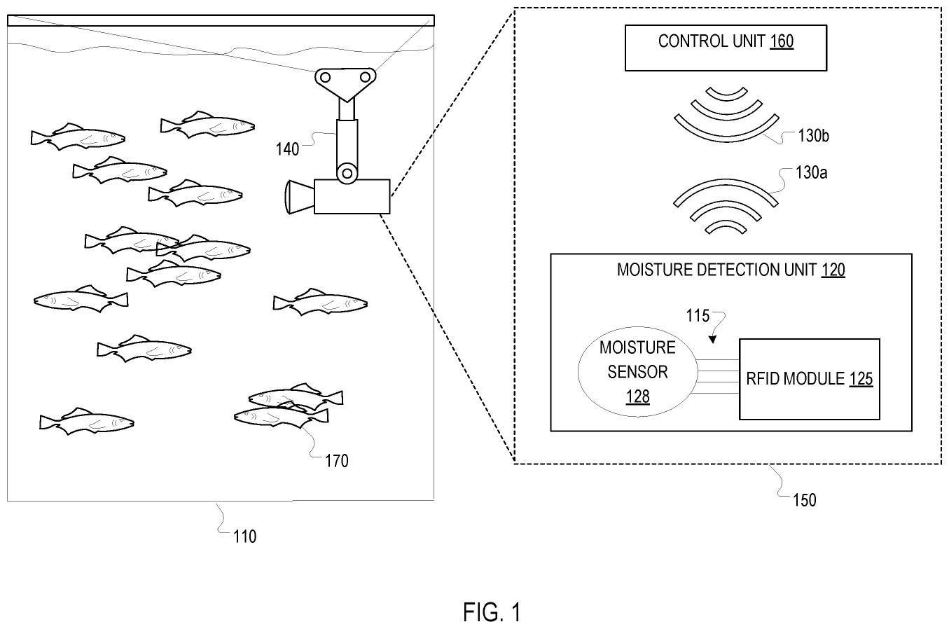

FIG. 1 is a schematic diagram of an example application of a moisture detection system 150. The moisture detection system 150 can be used to detect an amount of moisture at any appropriate location, e.g., in an electronic device, or any other type of appliance, instrument, apparatus, or any object or enclosure where the presence of moisture may be undesirable. For example, in some implementations, the moisture detection system 150 can be used to detect a leak in an electronic device where such leaks can impair proper functioning of the device. As a particular example, the moisture detection system 150 can be used to detect a leak within an enclosure (e.g., a cavity) of an underwater camera 140. Although in what follows the moisture detection system 150 is described in the context of marine applications, the moisture detection system 150 can generally be used in any other appropriate setting, e.g., the system 150 can be coupled to, and used to detect an amount of moisture in, a consumer product or a shipping box.

As shown in FIG. 1, an enclosure 110 can include aquatic livestock 170. The livestock 170 can be aquatic creatures, such as fish swimming freely within the confines of the enclosure 110. In some implementations, the aquatic livestock 170 can include finfish, juvenile fish, koi fish, sharks, salmon, bass, crustaceans, and others. In addition to the aquatic livestock, the enclosure 110 contains water, e.g., seawater, freshwater, or rainwater, although the enclosure 110 can contain any fluid that is capable of sustaining a habitable environment for the livestock 170. The enclosure 110 can further include an aquatic feeding system that delivers feeding pellets to the fish 170. In the example application illustrated in FIG. 1, the underwater camera 140 is disposed on a winch line and used to monitor the feeding behavior of fish 170, e.g., to obtain image/video data in order to detect the feeding pellets delivered by the feeding system.

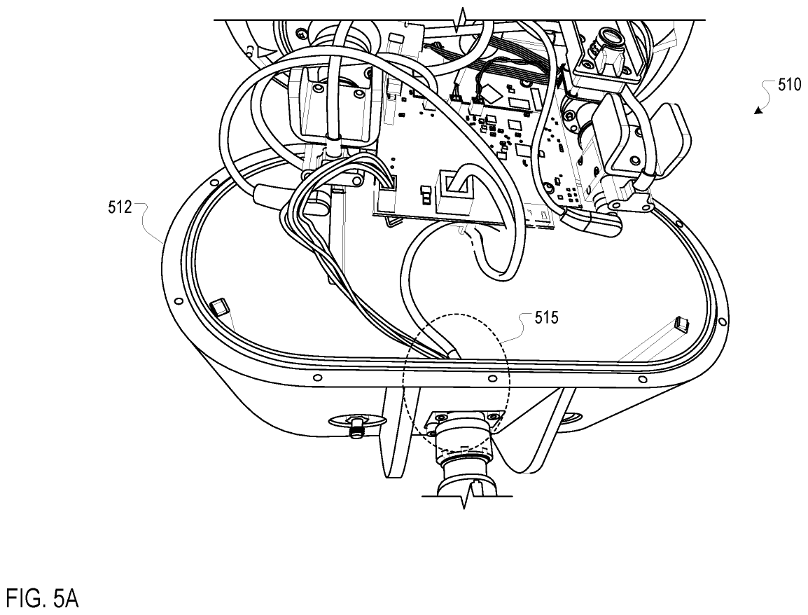

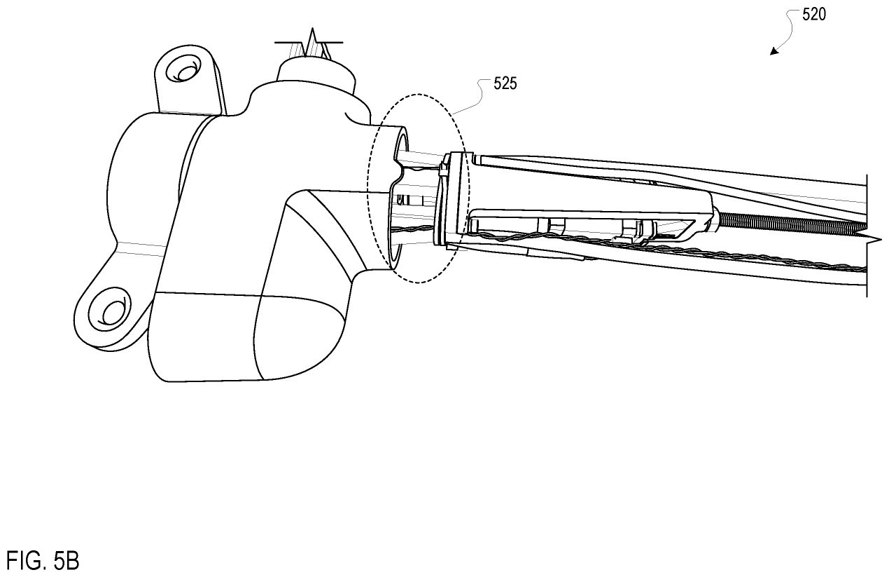

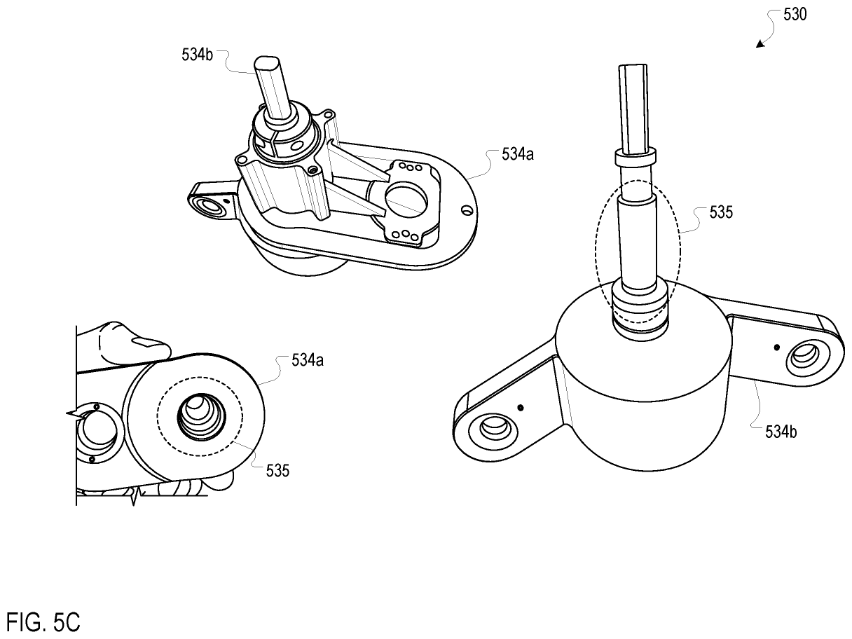

The moisture detection system 150 can be coupled to the underwater camera 140 in any appropriate manner and at any appropriate location within the camera 140. In some implementations, the moisture detection system 150 can be coupled to the underwater camera 140 with an adhesive. Example locations where the moisture detection system 150 can be disposed are described in more detail below with reference to FIG. 5A, FIG. 5B, and FIG. 5C. In some implementations, the moisture detection system 150 can be disposed within a sealed cavity of the underwater camera 140 that holds electronic circuit boards including a Graphical Processing Unit (GPU), and can be configured to detect an amount of moisture within the cavity. Typically, with extended use of the underwater camera 140, sea water can gradually leak and form a drainage path through the cavity, thereby facilitating corrosion and impairing proper functioning of the camera 140. Accordingly, it is desirable to detect any presence of moisture in the cavity as early as possible in order to prevent water from reaching the circuit boards and damaging the circuitry of the underwater camera 140 beyond repair.

The moisture detection system 150 can measure an amount of moisture using: (i) a moisture detection unit 120, and (ii) a control unit 160. In some implementations, the control unit 160 and the moisture detection unit 120 can each be placed at different locations within the underwater camera 140 and can be configured to communicate wirelessly. Each of the moisture detection unit 120 and the control unit 160 is described in more detail next.

The moisture detection unit 120 can include a moisture sensor 128 configured to obtain a measurement indicating an amount of moisture at a location where the moisture detection unit is installed (e.g., inside the camera cavity). The moisture detection unit 120 can be coupled to the underwater camera 140 in any appropriate manner. In one example, the moisture detection unit 120 can be attached to the camera cavity using an adhesive.

The moisture sensor 128 can include any appropriate material that is able to absorb at least a relatively small amount of moisture. In one example, the moisture sensor 128 can include a cotton pad with a pair, or multiple, wires 115 coupled to the cotton pad on each side of the cotton pad. When the cotton pad absorbs an amount of moisture (e.g., sea water), it can become conductive such that the resistance between the pair, or multiple, wires 115 can decrease. This change in resistance can be proportional to the amount of moisture absorbed by the cotton pad and can more generally indicate that moisture is present at a location where the cotton pad is disposed.

The wires 115 can couple the moisture sensor 128 to an RFID (Radio Frequency Identification) module 125 included in the moisture detection unit 120. In some implementations, the moisture sensor 128 and the RFID module 125 can further be coupled to each other with an adhesive. The RFID module 125 can be configured to receive the measurement from the moisture sensor 128 through one, or multiple, wires 115, and transmit a telemetry message 130a based on the moisture measurement as radio frequency waves.

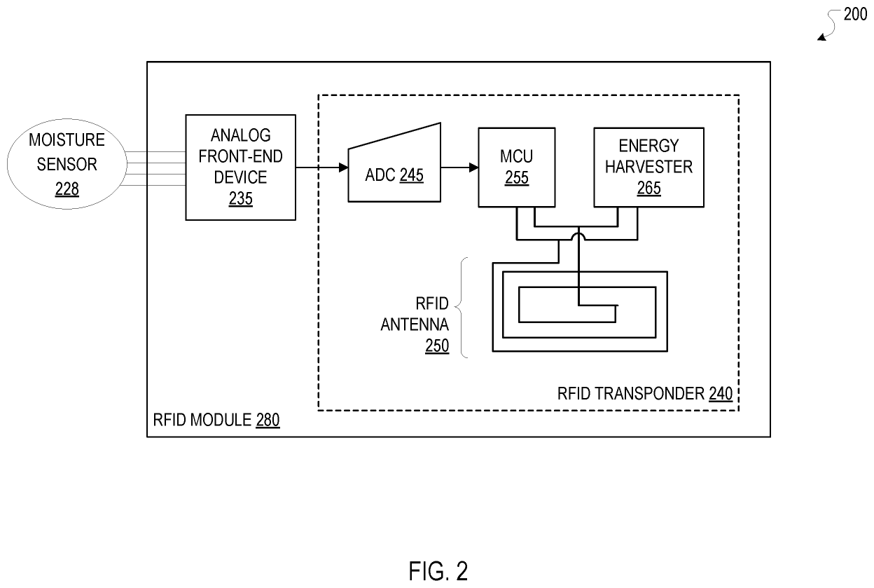

As described in more detail below with reference to FIG. 2, the RFID module 125 can receive the moisture measurement from the moisture sensor 128 and convert it into the telemetry message 130a. Specifically, the RFID module 125 can include a device that can be coupled to the moisture sensor 128 through one, or multiple, wires 115, and can be configured to receive a resistance measurement indicating the amount of moisture measured by the moisture sensor 128, and convert the resistance measurement into a corresponding voltage signal. As a particular example, such a device can be an analog front-end device. The RFID module 125 can further include a transponder that can be coupled to the analog front-end device and can be configured to receive the voltage signal from the analog front-end device and generate the corresponding telemetry message 130a. As a particular example, the transponder can be an ISO 15693 transponder with a built-in analog-to-digital converter.

The RFID module 125 can further include an RFID antenna that can be coupled to the transponder and can be configured to transmit the telemetry message 130a as radio frequency waves to the control unit 160. As a particular example, the radio frequency waves can have a frequency of 13.56 MHz. In some implementations, the RFID module can be configured to communicate wirelessly at a distance of, e.g., up to 1.5 meters. In some implementations, the moisture detection unit 120 can be passively-powered, e.g., powered without external energy sources such as batteries. In particular, as described in more detail below with reference to FIG. 2, the moisture detection unit 120 can be powered through the antenna from the RFID field.

Although a particular implementation of the moisture detection unit 120 is described above, the moisture detection unit 120 can additionally, or alternatively, include any other devices and components that can measure an amount of moisture and wirelessly transmit a corresponding telemetry message 130a to the control unit 160.

The control unit 160 can be configured to wirelessly receive the telemetry message 130b from the RFID module 125 and process it to determine the amount of moisture measured by the moisture sensor 128. For example, the control unit 160 can also include an RFID antenna that can wirelessly receive the telemetry message and provide it to one or more processing units (e.g., a Printed Circuit Board Assembly (PCBA)) included in the control unit 160. In some implementations, the control unit 160 can be configured to determine whether the amount of moisture measured by the moisture sensor 128 is above a particular threshold.

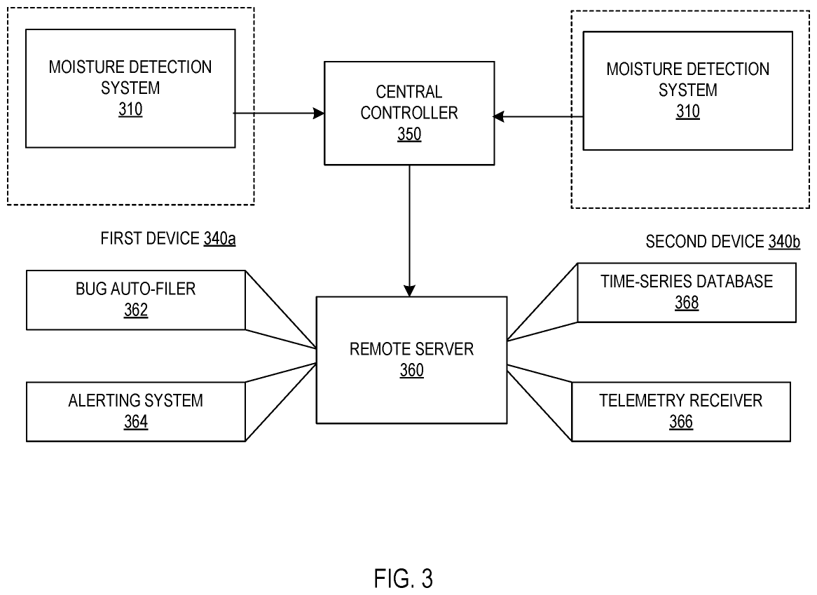

For example, as described in more detail below with reference to FIG. 3, if the control unit 160 determines that the amount of moisture measured by the moisture sensor 128 is above the threshold, the control unit 160 can automatically generate and forward an alert that indicates that a leak has been detected inside the camera 140 to a central controller (e.g., a controller located remotely from the moisture detection system 150). The central controller can automatically generate a response to the alert that can be, e.g., a request to a field service provider to replace the camera 140. In this manner, the moisture detection system 150 can automatically detect relatively small amounts of moisture in the underwater camera 140 and thereby prevent its deterioration.

In some implementations, the moisture detection system 150 can include multiple moisture detection units 120, each unit communicatively coupled to the control unit 160. For example, different moisture detection units 120 can be disposed at different locations inside the underwater camera 140, each moisture detection unit 120 being configured to measure an amount of moisture at the respective location and wirelessly communicate a respective telemetry message to the control unit 160. The control unit 160 can process each telemetry message and thereby determine an amount of moisture at different locations in the underwater camera 140.

Example moisture detection unit 120 is described in more detail next.

FIG. 2 is a block diagram of an example moisture detection unit 200 (e.g., the moisture detection unit 120 in FIG. 1) included in a moisture detection system (e.g., the moisture detection system 150 in FIG. 1). As described above with reference to FIG. 1, the moisture detection unit 200 can include: (i) a moisture sensor 228, and (ii) an RFID module 280, and can be configured to measure an amount of moisture at a location and transmit a corresponding telemetry message. A control unit can receive the telemetry message and process it to determine the amount of moisture present at the location. Generally, the control unit can be located anywhere within the range of wireless communication of the RFID module 280.

In some implementations, the moisture sensor 228 can include a cotton pad and salt, and can be configured to become electrically conductive in response to absorption of moisture. This can, in turn, generate a proportionate change in resistance of wires coupled to the moisture sensor 228, indicating that moisture has been absorbed by the cotton pad.

The RFID module 280 can include: (i) an analog front-end device 235, and (ii) an RFID transponder 240, each of which is described in more detail next.

The analog front-end device 235 can be coupled through wires to the moisture sensor 228, and can function as an interface between the sensor 228 and an analog-to-digital converter 245 included in the RFID transponder 240. As a particular example, the analog-to-digital converter 245 can be a 14-bit sigma-delta analog-to-digital converter. In some implementations, the analog front-end device 235 can be configured to amplify a measurement of a change in resistance of the wires, caused by an absorption of an amount of moisture by the moisture sensor 228, and convert it into a corresponding voltage signal. The analog-to-digital converter 245 can receive this voltage signal and convert it into a digital signal.

The RFID transponder 240 can further include a microcontroller 255 that can receive the digital signal from the analog-to-digital converter 245 and generate a corresponding telemetry message. As a particular example, the microcontroller can be a low-power MSP430 mixed-signal microcontroller, and the RFID transponder 240 can be an RF430FRL153H sensor transponder. An RFID antenna 250, coupled to the microcontroller 255, can wirelessly transmit the telemetry message corresponding to the moisture measurement to the control unit that can, in turn, wirelessly receive the telemetry message and process it to determine the amount of moisture measured by the sensor 228.

In some implementations, the RFID transponder 240 can further include an energy harvester 265 that can be configured to wirelessly receive energy for powering the moisture detection unit 200 through the RFID antenna 250. Specifically, the energy harvester 265 can use the antenna 250 to convert energy from the electromagnetic field into electrical energy, and supply this energy to the other components included in the moisture detection unit 200. As a particular example, the energy harvester 265 can be configured according to a 13.56-MHz H-field radio frequency. Because the moisture detection unit 200 is passively-powered, this obviates the need for external energy sources, such as batteries, allowing for the moisture detection unit 200 to operate effectively in different locations that may otherwise be difficult to access for the purpose of moisture measurements.

In some implementations, the RFID transponder 240 can further include an internal memory storage, e.g., an embedded universal FRAM nonvolatile memory storage, for storing program code or user data such as, e.g., calibration and measurement data. The RFID transponder 240 can further include additional components, e.g., an internal temperature sensor, a timer, or any other appropriate components. Generally, the moisture detection unit 200 can additionally, or alternatively, include any other appropriate components that enable it to perform its prescribed function.

Example moisture detection network that can include one or more moisture detection systems, each having a respective moisture detection unit 200, is described in more detail next.

FIG. 3 is a block diagram of an example moisture detection network 300. As illustrated in FIG. 3, the moisture detection network 300 can include multiple moisture detection systems 310 (e.g., multiple moisture detection systems 150 in FIG. 1), each coupled to a respective device, e.g., a first device 340a and a second device 340b. These devices 340a, 340b can be any appropriate devices or objects where a wireless measurement of moisture may be desirable. For example, each of the devices 340a, 340b can be a different underwater camera (e.g., the underwater camera 140 in FIG. 1). Generally, each of the devices 340a, 340b, and the moisture detection network 300, can include any appropriate number of moisture detection systems 310, e.g., 1, 2, 5, 10, 50, positioned at any appropriate location and coupled to any appropriate device or object.

As described above with reference to FIG. 1, the moisture detection system 310 can be configured to obtain a measurement indicating an amount of moisture within, the device 340a, the device 340b, or both, and process it to generate data that indicates the amount of moisture. The moisture detection system 310 can provide the data to a central controller 350 that can be located remotely from the devices 340a, 340b. In some implementations, the central controller 350 can be a site controller that is coupled to the moisture system 310 included in each of the devices 340a, 340b and configured to receive data indicating the amount of moisture from each of the respective devices 340a, 340b.

The central controller 350 can be coupled to a remote server 360 that is configured to receive the data from the central controller 350 and store it. For example, in some cases, the central controller 350 can process data indicating the amount of moisture and determine that the amount of moisture is below a particular threshold. In such cases, the central controller 350 can forward data to the remote server 360 for storage and take no further action. However, if the central controller 350 determines that the amount of moisture is above the threshold, the central controller 350 can forward data to the remote server 360 and trigger a corresponding action.

The moisture detection network can further include: i) a bug auto-filer 362, (ii) an alerting system 364, (iii) a time-series database 368, and (iv) a telemetry receiver 366.

The telemetry receiver 366 can be coupled to the remote server 360 and any other components of the network 300, and configured to acquire data from any component of the network 300 via wireless communication. The telemetry receiver 366 can generally be configured according to any appropriate wireless communication network. In some implementations, the telemetry receiver 366 can be configured to receive data from, and provide data to, the central controller 350. The time-series database 368 can be configured to store a time-series of moisture measurements that can be, e.g., data indicating the amount of moisture obtained at different points in time. The time-series data can generally indicate how the amount of moisture varies over time within the devices 340a, 340b.

The alerting system 364 can be configured to monitor incoming telemetry and generate an alert regarding failure of the device 340a, 340b. For example, the central controller 350 can receive data indicating the amount of moisture from the moisture detection system 310 included in the first device 340a and process it to determine if the amount of moisture is above a particular threshold. If the amount of moisture is above the threshold, the central controller 350 can send a corresponding request to the alerting system 364 that can automatically generate an alert in response to the request. In some implementations, the alert can indicate that the device needs to be replaced/repaired in order to mitigate damage to the device due to the presence of moisture.

The bug auto-filer 362 can be configured to automatically generate a request for an action in response to the data indicating the amount of moisture, or in response to the alert generated by the alerting system 364. The action can be any appropriate action. In one example, the bug auto-filer 362 can send a work request to a filed-service provider to replace the device. In another example, the bug auto-filer 362 can send a work request to a supply team to ship a replacement device. In yet another example, the bug auto-filer 362 can send a request to a failure analysis team to schedule a failure analysis and update failure tracking metrics.

In this manner, the moisture detection network 300 can use the wireless moisture detection systems 310, positioned at different locations, to wirelessly receive messages indicating amounts of moisture present at these locations and automatically request corresponding actions and/or perform corresponding device failure analysis. Accordingly, the network 300 can act as an early warning system to trigger customer field replacements and effectively minimize downtime and damage caused to the devices.

Example process that can be performed by the moisture detection system 310 is described in more detail next.

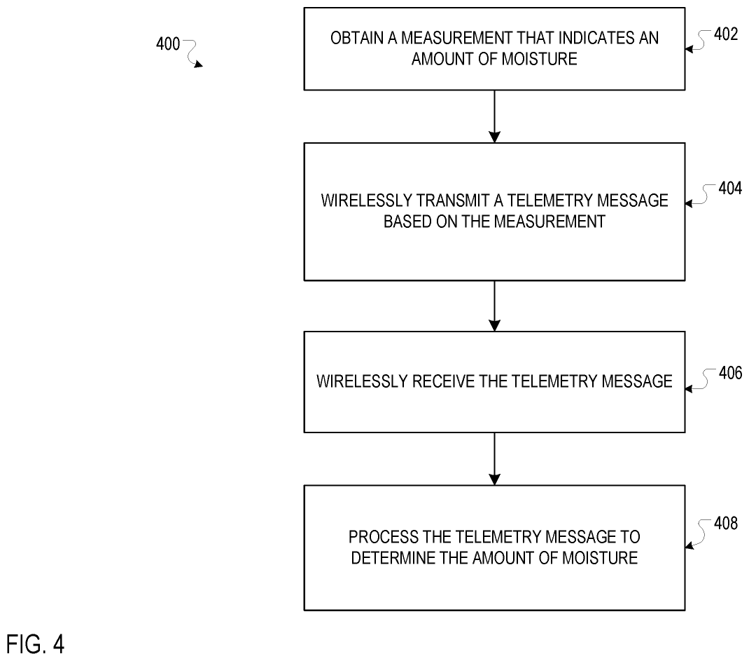

FIG. 4 is a flow diagram of an example process 400 for determining an amount of moisture using a moisture detection system. The process 400 can be performed using one or more computer-executable programs executed using one or more computing devices. In some implementations, the process 400 can be performed by a moisture detection system that includes: (i) a moisture detection unit including a moisture sensor and a Radio Frequency Identification (RFID) module coupled to the moisture sensor and configured to wirelessly receive energy for powering the moisture detection unit through an antenna, and (ii) a control unit communicatively coupled to the moisture detection unit. For example, the process 400 can be performed by the moisture detection system 150 in FIG. 1, or the moisture detection system 300 in FIG. 3.

The system obtains, by the moisture sensor, a measurement that indicates an amount of moisture (402). For example as described above with reference to FIG. 1, the moisture sensor 128 can be configured to obtain the measurement at a location where the moisture detection unit 120 is installed (e.g., inside a cavity of the underwater camera 140).

The system wirelessly transmits, by the RFID module and through the antenna, a telemetry message based on the measurement from the moisture sensor (404). For example, the RFID module can include: (i) an analog front-end device, and (ii) an RFID transponder. The analog-front-end device can be configured to receive the measurement from the moisture sensor and generate a corresponding voltage signal. The RFID transponder can receive the voltage signal and generate a corresponding telemetry message (e.g., radio frequency waves) that can then be transmitted by the antenna.

The system wirelessly receives, by the control unit, the telemetry message from the RFID unit (406). For example, the control unit can receive the telemetry message through an antenna similar to the one included in the moisture detection unit.

The system processes, by the control unit, the telemetry message to determine the amount of moisture measured by the moisture sensor (408). For example, the control unit 160 can process the telemetry message to determine if the amount of moisture at the location where the moisture detection unit 120 is installed is above a particular threshold. As described above with reference to FIG. 3, in some implementations, the control unit can be communicatively coupled to a central controller that can process data indicating the amount of moisture, the data received from the control unit, and generate and transmit a request for a corresponding action.

Example placements of the moisture detection unit included in the moisture detection system will be described in more detail next.

FIG. 5A illustrates an example placement 515 of a moisture detection unit included in a moisture detection system (e.g., the system 150 in FIG. 1, or the system 300 in FIG. 3). As illustrated in FIG. 5A, the placement 515 of the moisture detection unit can be inside a cavity 512 of an underwater camera 510 that also houses electronic components of the camera 510.

As described above with reference to FIG. 1, FIG. 2, and FIG. 3, the moisture detection unit can include a moisture sensor that can be configured to detect an amount of moisture inside the cavity 512. The moisture detection unit can then wirelessly transmit a telemetry message based on the amount of detected moisture to a control unit that can be disposed in any appropriate location in the camera 510. Because with extended use of the camera 510 the moisture (e.g., sea water) tends to gradually drip down and pool up inside the cavity 512, this placement 515 of the moisture detection unit may be desirable in order to detect any moisture early on and to prevent damaging the electronics of the camera 510. In some implementations, multiple moisture detection units can be disposed inside the cavity 512 of the camera 510, each unit configured to detect an amount of moisture at the respective location inside the cavity 512 and transmit a respective telemetry message to the control unit.

FIG. 5B illustrates another example placement 525 of a moisture detection unit included in a moisture detection system (e.g., the system 150 in FIG. 1, or the system 300 in FIG. 3). As illustrated in FIG. 5B, the placement 525 of the moisture detection unit can be in, or around, a pan motor assembly 520 of an underwater camera (e.g., the camera 510 in FIG. 5A).

FIG. 5C illustrates another example placement 535 of a moisture detection unit included in a moisture detection system (e.g., the system 150 in FIG. 1, or the system 300 in FIG. 3). As illustrated in FIG. 5C, the placement 535 of the moisture detection unit can be inside a winch key 530.

Specifically, the winch key 530 can include a first part 534a and a second part 534b coupled to each other. The placement 535 of the moisture detection unit can be between two seals (e.g., O-ring seals) connecting the first part 534a and the second part 534b and inside the winch key 530. Generally, it may be difficult to detect moisture in the region 535 of the winch key 530 because it would require connecting electronics across the seals. However, the moisture detection unit described in this specification is able to communicate a telemetry message indicating an amount of moisture wirelessly. Accordingly, in contrast to currently available solutions, the moisture detection unit can be placed in difficult-to-reach areas, such as the area 535, and facilitate measurements of moisture at that location.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

1. A moisture detection system, comprising:
a moisture detection unit comprising:
a moisture sensor configured to obtain a measurement that indicates an amount of moisture; and
a Radio Frequency Identification (RFID) module coupled to the moisture sensor through a plurality of wires, wherein the RFID module includes an antenna and is configured to wirelessly transmit a telemetry message based on the measurement from the moisture sensor through the antenna and is further configured to wirelessly receive energy for powering the moisture detection unit through the antenna; and
a control unit communicatively coupled to the moisture detection unit, wherein the control unit is configured to wirelessly receive the telemetry message from the RFID module and process the telemetry message to determine the amount of moisture measured by the moisture sensor.

2. The system of claim 1, wherein the moisture detection unit is disposed within an enclosed cavity of a device, and wherein the antenna is configured to wirelessly transmit the telemetry message from within the enclosed cavity and to the control unit.

3. The method of claim 1, wherein the moisture detection unit is coupled to an object, and wherein the control unit is remote from the object.

4. The system of claim 1, wherein the moisture sensor comprises an absorbent pad configured to absorb the moisture, and wherein the measurement that indicates the amount of moisture is based on a resistance of the absorbent pad as measured by the plurality of wires.

5. The system of claim 4, wherein the absorbent pad includes cotton, salt, and water.

6. The system of claim 1, wherein the RFID module and the moisture sensor are coupled to each other through an adhesive.

7. The system of claim 1, wherein the RFID module comprises:
an analog front-end device coupled to the moisture sensor through the plurality of wires and configured to both receive the measurement from the moisture sensor and generate a corresponding voltage signal; and
an RFID transponder configured to receive the voltage signal from the front-end device and generate the telemetry message based on the voltage signal.

8. The system of claim 7, wherein the RFID transponder comprises:
an analog-to-digital converter configured to receive the voltage signal from the analog front-end device and convert it to a digital signal;
a microcontroller configured to receive the digital signal from the analog-to-digital converter and generate the telemetry message; and
wherein the antenna is configured to receive the telemetry message and wirelessly transmit the telemetry message to the control unit.

9. The system of claim 8, wherein the RFID transponder is configured to have a wireless transmission range of up to 1.5 meters.

10. The system of claim 1, wherein the moisture detection unit is coupled with an adhesive to an enclosure of a device, and wherein the measurement that indicates the amount of moisture indicates the amount of moisture inside the enclosure.

11. The system of claim 1, wherein the moisture detection unit is coupled with an adhesive to an enclosed cavity of an underwater camera, and wherein the measurement that indicates the amount of moisture indicates the amount of moisture inside the enclosed cavity.

12. The system of claim 1, wherein the moisture sensor is configured to automatically and periodically obtain the measurement that indicates the amount of moisture.

13. The system of claim 1, wherein the control unit is configured to generate a time series of moisture measurements indicating the amount of moisture measured by the moisture sensor at different time points.

14. The system of claim 1, further comprising a power source that is configured to power the moisture detection unit and the control unit.

15. The system of claim 1, further comprising an alert unit configured to automatically generate an alert in response to the control unit determining that the amount of moisture measured by the moisture sensor satisfies an alert criteria.

16. The system of claim 1, wherein the moisture detection unit comprises a plurality of moisture sensors at different locations, each moisture sensor being coupled to the RFID module, and each moisture sensor configured to obtain a respective measurement that indicates a respective amount of moisture at a respective location of the different locations.

17. A method comprising:
obtaining, by a moisture sensor of a moisture detection system that includes: (i) a moisture detection unit comprising the moisture sensor and a Radio Frequency Identification (RFID) module coupled to the moisture sensor and configured to wirelessly receive energy for powering the moisture detection unit through an antenna, and (ii) a control unit communicatively coupled to the moisture detection unit, a measurement that indicates an amount of moisture;
wirelessly transmitting, by the RFID module and through the antenna, a telemetry message based on the measurement from the moisture sensor;
wirelessly receiving, by the control unit, the telemetry message from the RFID unit; and
processing, by the control unit, the telemetry message to determine the amount of moisture measured by the moisture sensor.

18. One or more non-transitory computer-readable storage medium coupled to one or more processors that, when executed by the one or more processors, cause the one or more processors to perform operations comprising:
obtaining, by a moisture sensor of a moisture detection system that includes: (i) a moisture detection unit comprising the moisture sensor and a Radio Frequency Identification (RFID) module coupled to the moisture sensor and configured to wirelessly receive energy for powering the moisture detection unit through an antenna, and (ii) a control unit communicatively coupled to the moisture detection unit, a measurement that indicates an amount of moisture;
wirelessly transmitting, by the RFID module and through the antenna, a telemetry message based on the measurement from the moisture sensor;
wirelessly receiving, by the control unit, the telemetry message from the RFID unit; and
processing, by the control unit, the telemetry message to determine the amount of moisture measured by the moisture sensor.
